(19) United States
(12) Patent Application Publication
(10) Pub. No.: US 2015/0111620 A1
(43) Pub. Date: Apr. 23, 2015

(54) EARPHONE-INTEGRATED MOBILE TERMINAL CASE

(71) Applicant: ELSROD INOTEC CO., LTD., Seoul (KR)

(72) Inventor: Seok Ha HWANG, Namyangju-si (KR)

(73) Assignee: ELSROD INOTEC CO., LTD., Seoul (KR)

(21) Appl. No.: 14/225,927

(22) Filed: Mar. 26, 2014

(30) Foreign Application Priority Data
Oct. 22, 2013 (KR) 20-2013-0008681

(51) Int. Cl. H04B 1/38; H04M 1/725; H04M 1/60

(52) U.S. Cl. CPC H04B 1/3888; H04M 1/6058; H04M 1/72527
USPC 455/569.1

(57) ABSTRACT

An earphone-integrated mobile terminal case includes: a first case configured to form a housing, in which a mobile terminal can be accommodated in the housing; a second case coupled to an opposite side of the housing of the first case, in which the second case is configured to include an aperture to expose an earphone speaker of an earphone to an outside; an earphone jack positioned in a location of the first case, in which the earphone jack can be coupled to an audio output port of the mobile terminal when the mobile terminal is accommodated in the housing of the first case in accordance with a design specification of the mobile terminal; and a winding roller configured to be included in an inside space formed by the first case and the second case, in which the winding roller is further configured to wind an earphone line of the earphone.

### CROSS-REFERENCE TO RELATED APPLICATIONS

This application claims priority to and the benefit of Korean Patent (Utility Model) Application No. 20-2013-008681 filed in the Korean Intellectual Property Office on Oct. 22, 2013, the entire contents of which are incorporated herein by reference.

### TECHNICAL FIELD

The present invention relates to a mobile terminal case, and more particularly, to an earphone-integrated mobile terminal case.

### BACKGROUND ART

As the technologies for mobile terminals are developed, mobile terminals having various functions such as playing music and watching video have been marketed. Also, since such mobile terminals having various functions have been small-sized in recent years, there are problems in that internal parts of the mobile terminals may be damaged or malfunction due to impact applied from the outside.

Meanwhile, the mobile terminal generally includes an audio output port. Generally, the earphone is connected to the audio output port of the mobile terminal so as to improve portability and convenience, and protect privacy. When the mobile earphone is carried while being connected to the mobile terminal, an earphone line is connected between an earphone jack and an earphone speaker so as to transfer an output from the audio output port of the mobile terminal to the earphone speaker.

However, when managing the earphone by carrying the same, the earphone line may be frequently twisted or tangled. Accordingly, users have managed the earphone line by managing the earphone line separately from the mobile terminal or winding the earphone line.

Korean Patent Application No. 10-2011-0035322 suggests an earphone case including a winding roll for winding an earphone line.

### SUMMARY OF THE INVENTION

The present invention has been made in an effort to provide an earphone-integrated mobile terminal case.

The present invention has also been made in an effort to provide an earphone-integrated mobile terminal case, thereby safely protecting earphone and a mobile terminal, and easily managing the earphone due to the earphone integrated within the case.

The present invention has also been made in an effort to provide an earphone-integrated mobile terminal case which enables a user to select whether to output an audio signal from the mobile terminal through the earphone or a speaker of the mobile terminal, in a state where a jack of the earphone is inserted into the mobile terminal.

An exemplary embodiment of the present invention provides an earphone-integrated mobile terminal case including: a first case configured to form a housing, in which a mobile terminal can be accommodated in the housing; a second case coupled to an opposite side of the housing of the first case, in which the second case is configured to include an aperture to expose an earphone speaker of an earphone to an outside; an earphone jack positioned in a location of the first case, in which the earphone jack can be coupled to an audio output port of the mobile terminal when the mobile terminal is accommodated in the housing of the first case in accordance with a design specification of the mobile terminal; and a winding roller configured to be included in an inside space formed by the first case and the second case, in which the winding roller is further configured to wind an earphone line of the earphone.

The earphone can be enabled or disabled by a user's selection. The earphone can be enabled or disabled based on a control of a hardware switch, and can be controlled based on a control of a control switch of software.

According to the earphone-integrated mobile terminal case of the exemplary embodiments of the present invention, it is possible to safely protect the earphone and the mobile terminal.

According to the earphone-integrated mobile terminal case of the exemplary embodiments of the present invention, it is also possible to easily manage the earphone because the earphone is integrated within a mobile terminal case.

According to the earphone-integrated mobile terminal case of the exemplary embodiments of the present invention, it is also possible to variously manipulate an audio output type of the mobile terminal while using the integrated case because a user can select a medium through which an audio signal from the mobile terminal is output, even in a state where an earphone jack is inserted into the mobile terminal.

### BRIEF DESCRIPTION OF THE DRAWINGS

Some exemplary embodiments are illustrated in the accompanying drawings so that the features of the present disclosure described in the above can be understood in more detail and more particularly with reference to the following exemplary embodiments. Also, like reference numerals in the drawings are intended to denote functions identical with or similar to the reference numerals in various aspects.

However, the accompanying drawings are illustrative only for specific typical exemplary embodiments of the present disclosure, and are not considered limiting the scope of the present invention, and it should be noted that other exemplary embodiments having the same effect can be sufficiently recognized.

FIG. 1 is a rear prospective view of a mobile terminal case according to an exemplary embodiment of the present invention.

FIG. 2 is side views of the mobile terminal case according to the exemplary embodiment of the present invention.

FIG. 3 is a perspective view of the cases in a separated state according to the exemplary embodiment of the present invention.

FIG. 4 is a perspective view of the cases in a separated state according to the exemplary embodiment of the present invention.

FIG. 5 is an enlarged view of a first case according to the exemplary embodiment of the present invention.

FIG. 6 is a perspective view of the first case from which a winding roller is separated according to the exemplary embodiment of the present invention.

FIG. 7 is a perspective view of the winding roller, which is separated from the first case, according to the exemplary embodiment of the present invention.

FIG. 8 is an exploded view of components of the winding roller according to the exemplary embodiment of the present invention.

FIG. 9 is a perspective view of the first case (inner layer) of an earphone-integrated mobile terminal case according to the exemplary embodiment of the present invention.

### DETAILED DESCRIPTION

Various exemplary embodiments and/or aspects will be disclosed with reference to the accompanying drawings. A plurality of detailed matters is disclosed for helping overall understanding of one or more aspects for the purpose of description in the following description. However, it will also be recognized by a person with ordinary skill in the art to which the present invention pertains that these aspects can be implemented without such detailed matters. Hereinafter, specific exemplary aspects for one or more aspects will be described in detail in the following description with reference to the accompanying drawings. However, these aspects are illustrative only, and various methods in principles for various aspects can be partially used, and the following description is intended to include all the aspects and equivalents thereto.

In addition, the term “or” is intended to mean inclusive “or”, not exclusive “or”. That is, unless otherwise specified or if contextually unclear, “X uses A or B” is intended to mean one of the natural inclusive substitutions. That is, when X uses A, X uses B, or X uses both A and B, “X uses A or B” can be applied to all three cases. Also, it should be understood that the term “and/or” used in the present specification indicates and includes all the possible combinations of one or more items among enumerated related items.

The term “include (comprise)” and/or “including (comprising)” means that a corresponding characteristic and/or constituent element are present, but should be understood not to exclude the presence or the addition of one or more other characteristics, constituent elements and/or a group thereof. Further, unless otherwise specified or if it is contextually unclear that the term indicates a singular form, it should be understood that a singular form in the present specification and the claims generally means “one or more”.

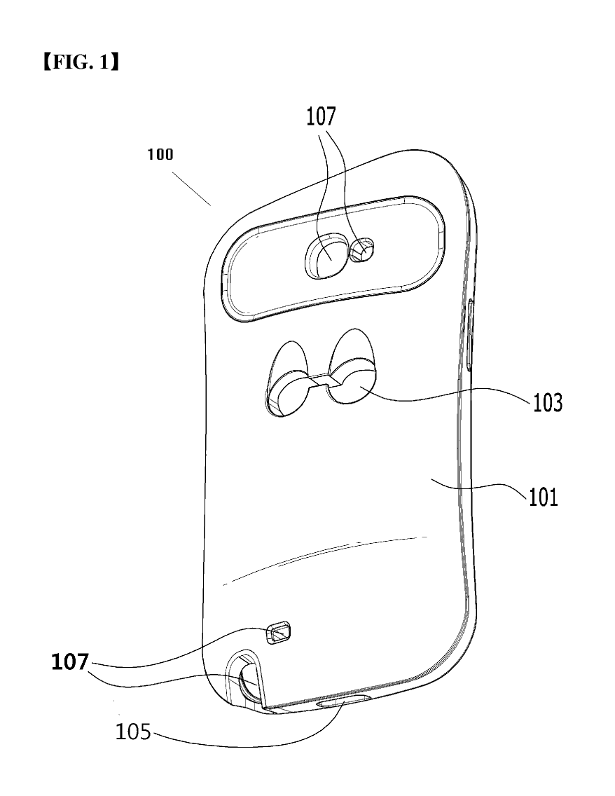

FIG. 1 is a rear perspective view of a mobile terminal case according to an exemplary embodiment of the present invention. Here, a mobile terminal may be called a cellphone, a cellular phone, a cellular, a cellular terminal, a device, a subscriber unit, a subscriber station, a mobile station, a terminal, a remote station, a remote terminal, an access terminal, a user terminal, a radio communication device, a user agent, a user device, user equipment, or the like.

As illustrated in FIG. 1, a mobile terminal case 100 according to the exemplary embodiment of the present invention may include a first case (inner layer) 110, a second case (outer layer) 101, an earphone aperture 103 for exposing earphone to the outside, an external port aperture 105 for connection with an external port such as a charger port and/or a USB port, and a terminal module aperture 107 for exposing modules, such as a camera, a speaker, a touch pen and/or a flash or a light of the mobile terminal, to the outside. In an additional aspect of the present invention, with respect to the apertures (for example, the external port aperture 105), the aforementioned functions are only an example, and the apertures may also have a function of exposing specific components of the mobile terminal (for example, the speaker or the touch pen) to the outside.

The first case 110 may form a housing for accommodating the mobile terminal. The mobile terminal is mounted to the housing formed in the first case 110 such that the mobile terminal may be surrounded by the first case 110 to be protected from external force.

The first case 110 may be made of an elasticity material having elasticity in order to protect the mobile terminal and easily accommodate the mobile terminal in the housing of the first case 110. Examples of the elasticity material configuring the first case 110 may include a synthetic resin having elasticity such as polyvinyl acetate, polyurethane, rubber or silicone. In an aspect of the present invention, a circumference of the first case 110 may be manufactured by an injection molding method such that the first case 110 may be easily coupled to the second case 101 which is made of, for example, a plastic material different from the material of the first case 110.

The first case 110 may be produced in a customized manner in accordance with an external structure of a mobile terminal. An external appearance of a mobile terminal is variously designed and produced according to a manufacturer, a model, and a model year, and as a result, the mobile terminal case 100 may be manufactured as a mobile terminal case dedicated for a specific terminal. In this case, the first case 110 may form the housing so that the first case 110 may come into close contact with and be coupled to the mobile terminal in accordance with the external appearance of the mobile terminal.

Although not illustrated in FIG. 1, earphone may be integrally coupled to the first case 110. In this case, according to a position of an earphone port due to a design specification of the mobile terminal, the earphone may be integrally coupled to a specific position of the first case 110 that accommodates the mobile terminal Accordingly, when the mobile terminal is accommodated in the housing in the first case 110, an earphone jack may be inserted into the earphone port of the mobile terminal.

According to an aspect of the present invention, the second case 101 (outer layer) may be coupled to the first case (inner layer) 110. End portions of an inner surface of the second case 101 may come into contact with and be coupled to end portions of a back surface of the first case 110. For example, the second case 101 may have the same circumference as that of the first case 110 so as to surround the entire first case 110. Additionally, the second case 101 may surround at least a part of the first case 110. An inside space may be formed by the coupling of the second case 101 and the first case 110. Internal components such as a winding roller and an earphone receiver may be installed or disposed inside the space. In an exemplary embodiment of the present invention, a back surface of the second case 101 may have at least one convex portion in order to form a space where the internal components are installed or disposed. For example, at least one of a central portion, an upper portion, and a lower portion of the second case 101 may have a convex shape.

The second case 101 may be made of a curable material such as a plastic material, or a material having plasticity. Otherwise, the second case 101 may be made of the elasticity material that is the same as or different from that of the first case 110.

The earphone aperture 103 of the second case 101 for exposing the earphone to the outside may be formed on the second case 101. In an aspect of the present invention, the earphone aperture 103 of the second case 101 for exposing the earphone to the outside may be formed at an upper portion of the second case 101. Here, the upper portion may mean a portion above the central portion of the second case 101. That is, the upper portion may mean a portion above the position that is half way in a lengthwise direction of the second case 101. Otherwise, the upper portion may mean a portion above the convex shape which is formed on the back surface of the second case 101.

Generally, users frequently use the terminal mobile while gripping a lower portion of a back side of the mobile terminal instead of an upper portion thereof. Accordingly, when the earphone aperture 103 capable of exposing the earphone is formed at the upper portion of the mobile terminal as described above, it is possible to make the users more stably and conveniently grip the mobile terminal.

In an aspect of the present invention, the terminal module aperture 107 for exposing modules, such as a camera, a speaker and/or a flash or a light of the mobile terminal, to the outside may be formed at an upper portion of the earphone aperture 103 of the second case 101. The first case 110 and the second case 101 may also include the terminal module aperture 107 at corresponding positions, respectively. The terminal module aperture 107 may be formed to match the positions of the modules of the terminal in accordance with a design specification of the mobile terminal.

In an additional aspect of the present invention, as illustrated in FIG. 1, a large-sized aperture may be formed at the upper portion of the earphone aperture 103 of the second case 101 so that it is possible to expose the modules of the mobile terminal and/or the first case to the outside regardless of a design specification of the mobile terminal. In this case, in order to protect the mobile terminal from external force, the terminal module aperture 107 of the first case 110 may expose the specific modules within the mobile terminal to the outside in accordance with a design specification of the mobile terminal. That is, in accordance with a design specification of the mobile terminal, the modules of the mobile terminal may be present at various positions. Accordingly, the aperture may be formed at positions corresponding to the positions of the modules of the mobile terminals in order to conform to a design specification of the mobile terminal. Only the modules of the mobile terminal, which need to be exposed to the outside, are appropriately exposed, and the remaining body portion may be protected from external force by the case. Other apertures to be described below may also be disposed at specific positions of the case in the same manner.

In an aspect of the present invention, the first case 110 and the second case 101 may form the external port aperture 105 at corresponding positions, respectively, in accordance with a design specification of the mobile terminal

Additionally, the second case 101 may form a large-sized external port aperture and thus expose the external ports of the mobile terminal and/or the first case to the outside, regardless of a design specification of the mobile terminal. In this case, in order to protect the mobile terminal from external force, the terminal module aperture 107 of the first case 110 may expose the external port of the mobile terminal to the outside so as to conform to a design specification of the mobile terminal

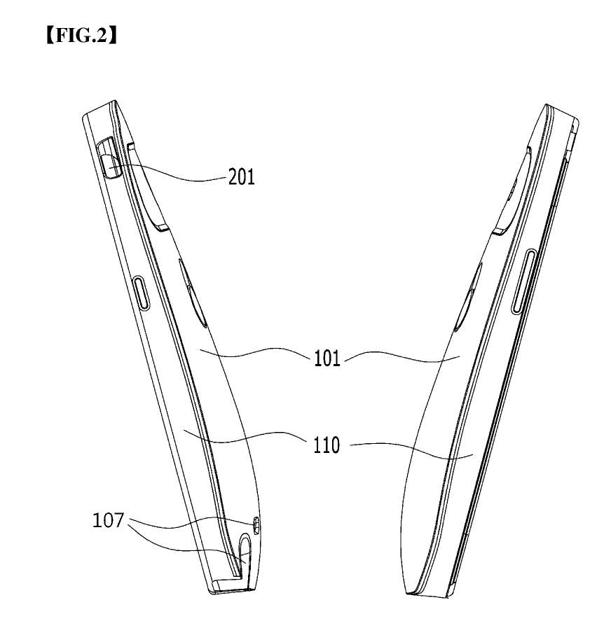

FIG. 2 is side views illustrating the mobile terminal case according to the exemplary embodiment of the present invention. A specific portion of the mobile terminal case 100 may have a convex shape so as to form a specific space where the coupling of the first case 110 and the second case 101 are coupled.

A space (that is, a winding roller) for accommodating an earphone line of the earphone is formed inside the mobile terminal case 100 according to the exemplary embodiment of the present invention. Accordingly, as illustrated in FIG. 2, one specific portion of the mobile terminal case has a convex shape. For example, the specific portion may mean a lower portion. Also, an antenna aperture 201 for exposing an antenna of the mobile terminal, and the like to the outside is formed at one side of the mobile terminal case. A position of the antenna aperture 201 may also be formed to conform to a design specification of the mobile terminal.

As illustrated in FIGS. 1 and 2, the mobile terminal case 100 according to the exemplary embodiment of the present invention may accommodate the mobile terminal in the housing (that is, inner surface) of the first case. The mobile terminal accommodated as described above may be brought into close contact within and fixed to the housing. Also, the earphone line of the earphone may be wound and accommodated within the mobile terminal case 100. Further, an earphone speaker, which is connected to the earphone line wound in this way, may be taken out to the outside through the earphone aperture 103. That is, the mobile terminal case 100 according to the exemplary embodiment of the present invention may protect the mobile terminal from external impact and fix the earphone to the inside of the case.

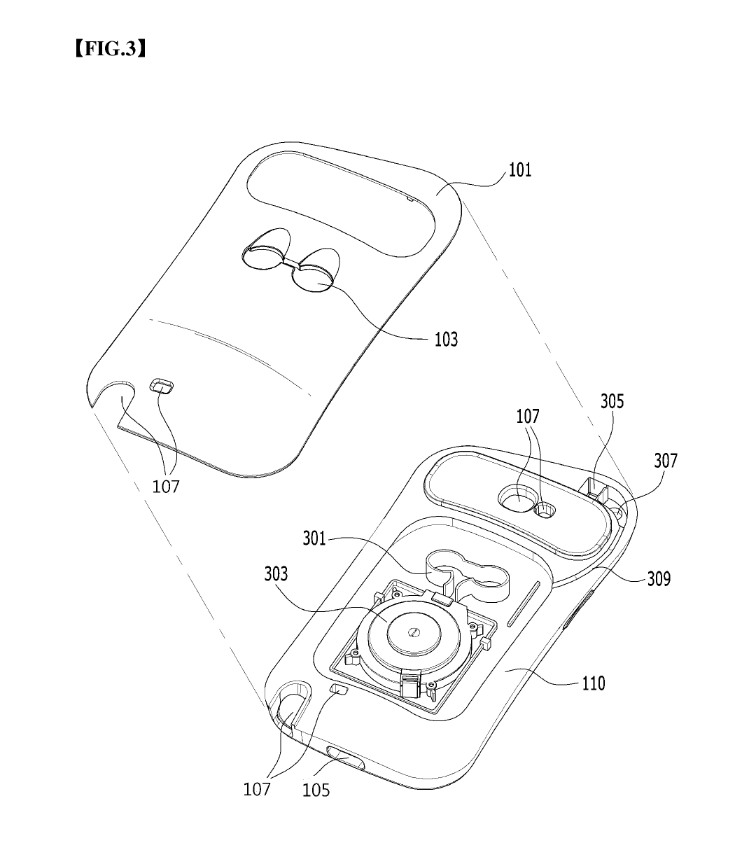

FIG. 3 is a perspective view illustrating outer surfaces of the cases in a separated state according to the exemplary embodiment of the present invention. As described above, the second case 101 includes the earphone aperture 103 for exposing the earphone, and the earphone aperture 103 of the second case 101 may be formed at a position corresponding to an earphone receiver 301 of the first case 110. According to an additional exemplary embodiment of the present invention, at least a part of the earphone aperture 103 may be covered by a cover for fixing the earphone speaker.

As illustrated in FIG. 3, the first case 110 may include the external port aperture 105 for connection with an external port, such as a charger port and/or a USB port, and the second case 101 may also include the external port aperture 105 for connection with an external port, such as a charger port and/or a USB port, at a position corresponding to the first case 110.

As illustrated in FIG. 3, the back surface of the first case may include an earphone jack receiver 305 which forms a space for receiving the earphone jack, an earphone line path 309 for fixing the earphone line so that the earphone line of the earphone is connected to a winding roller 303, a switch receiver 307 which forms a space for receiving a switch for controlling ON/OFF of the earphone, the winding roller 303 in which the earphone line may be wound, and the earphone receiver 301 for fixing the speaker of the earphone.

According to an aspect of the present invention, the earphone jack receiver 305 may form a space capable of receiving the earphone jack. The earphone jack receiver 305 may include an aperture at a position corresponding to a position of an audio output port of the mobile terminal In this case, the earphone jack may pass through the aperture and be connected to the audio output port of the mobile terminal.

Although not illustrated in FIG. 3, the earphone jack is integrally coupled to the first case 110 within the earphone jack receiver 305. Accordingly, in accordance with a design specification of each mobile terminal, when the mobile terminal is accommodated (that is, mounted) in the housing of the first case 110, the earphone jack coupled to the first case 110 may be connected to the audio output port of the mobile terminal.

Additionally, the earphone jack within the earphone jack receiver 305 may be coupled to the first case 110 so as to be detachable from the first case 110. In this case, when the lifespan of the earphone jack ends, the earphone jack may be easily separated from the first case 110, which makes it easy to replace the earphone jack.

According to an aspect of the present invention, the earphone line of the earphone may be fixed to a groove formed in the earphone line path 309 and connected to the winding roller 303 along the path 309. Further, a ring-shaped fastening portion is coupled to the groove of the earphone line path 309 so as to more effectively fix the earphone line.

Additionally, the earphone line path 309 may also have a tube or pipe shape so as to penetrate the inside of the first case 110 in a longitudinal direction thereof. In this case, the earphone line of the earphone may be embedded in the first case 110.

The winding roller 303 in FIG. 3 may be made of a material different from that of the first case 110. Otherwise, the winding roller 303 may also be made of, for example, an elasticity material which is the same as or different from that of the first case 110.

The winding roller 303 may be manufactured separately from the first case 110 during an assembly process. In this case, the winding roller 303 may be independently manufactured so as to be installed at a specific position of the first case 110.

Although not illustrated in FIG. 3, a cylindrical projection is formed inside the winding roller 303. The earphone line of the earphone may be fixed through a groove formed around a cylindrical rotating portion having a central part into which the cylindrical projection is inserted. Further, when the cylindrical rotating portion rotates about the cylindrical projection, the earphone line of the earphone may be wound to or unwound from the cylindrical rotating portion.

In an additional exemplary embodiment of the present invention, the winding roller 303 may be configured so that the earphone line of the earphone is automatically wound or unwound by rotating the rotating portion with elastic restoring force of a spring and the like.

According to an aspect of the present invention, the winding roller 303 may include two apertures (inlet and outlet) for leading or drawing the earphone line of the earphone. The earphone may be led from the earphone line path 309 through the inlet. The earphone may be connected to the earphone receiver 301 through the outlet. As illustrated in FIG. 3, the earphone receiver 301 may have a shape similar to that of the earphone speaker of the earphone so that the earphone is suitably fixed into the earphone receiver 301. The earphone receiver 301 may be integrally formed with the first case 110.

According to an aspect of the present invention, the earphone may be enabled or disabled by a user's selection. That is, a user may select whether to output an audio signal from the mobile terminal through the earphone speaker of the earphone or the speaker of the mobile terminal, without drawing the earphone jack. Such an operation may be controlled by a switch installed in the switch receiver 307 denoted by reference numeral 307 in FIG. 3.

In an aspect of the present invention, the switch may include a hardware switch. The hardware switch may change an electrical connection between the earphone jack and the earphone line. In this case, the hardware switch may be exposed to an inner surface direction (that is, the direction toward the housing) of the first case 110 through the switch receiver 307 in which the switch may be installed.

In an additional aspect of the present invention, switching operations may also be controlled by a software control switch that is controlled by software. That is, the user may control whether to output an audio signal through the earphone speaker of the earphone or the speaker of the mobile terminal through a program (for example, an application) installed in the mobile terminal. In an aspect of the present invention, the output of the earphone jack may be limited by software.

Accordingly, by the aforementioned technical feature, even though the earphone jack is inserted into the mobile terminal, the user may control a specific function, such as an alarm, a telephone call, and a text message, which requires an output of the speaker, to be output through the speaker of the mobile terminal, in accordance with the user's own selection.

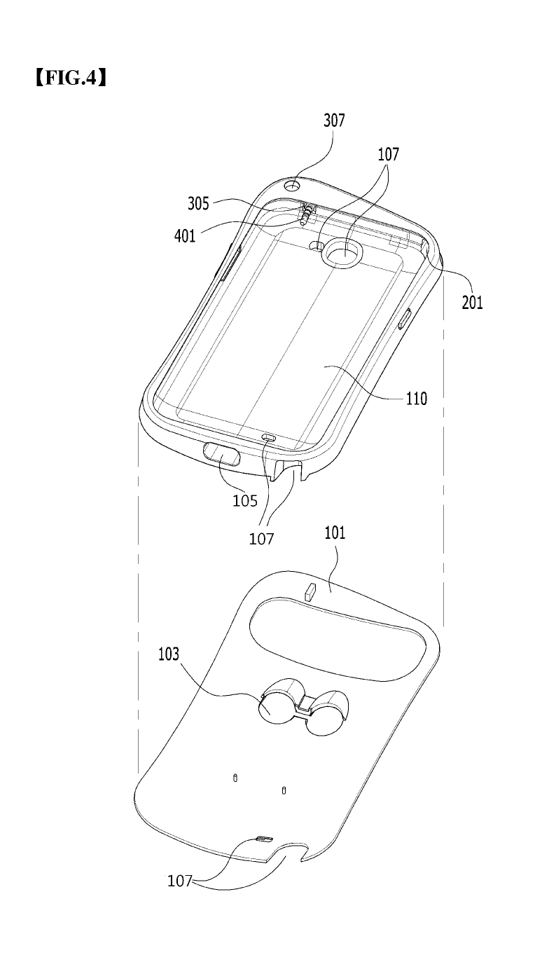

FIG. 4 is a perspective view illustrating inner surfaces of the cases in a separated state according to the exemplary embodiment of the present invention. As illustrated in FIG. 4, the inner surface of the first case 110 may form a space where the mobile terminal may be inserted.

As described above, the second case 101 may include the earphone aperture 103 for exposing the earphone. Also, the first case 110 and the second case 101 may include the external port aperture 105 for connection with an external port such as a charger port and/or a USB port at corresponding positions, respectively. Further, the first case 110 and the second case 101 may include the terminal module aperture 107 for exposing modules, such as a camera, a speaker and/or a flash or a light of the mobile terminal, to the outside at corresponding positions, respectively. As described above, the terminal module aperture of the second case 101 may be wider than the terminal module aperture of the first case 110. Also, the antenna aperture 201 for exposing an antenna of the mobile terminal, and the like to the outside is formed at one side of the first case 110.

According to an aspect of the present invention, the first case 110 may include the earphone jack receiver 305 for receiving an earphone jack 401. The earphone jack 401 is integrally coupled to the first case 110 in the earphone jack receiver 305. The earphone jack 401 may be connected with the port of the mobile terminal while passing through the aperture that is formed in a direction toward the audio output port of the mobile terminal in the earphone jack receiver 305. That is, when the mobile terminal is accommodated in the housing of the first case 110, the earphone jack 401 coupled to the first case 110 may be automatically connected with the audio output port of the mobile terminal. In an aspect of the present invention, positions and external appearances of the earphone jack 401 and the earphone jack receiver 305, to which the earphone jack 401 is attached, may be changed in accordance with a design specification of the mobile terminal.

In an aspect of the present invention, the earphone may be enabled or disabled based on a control of the switch installed in the switch receiver 307. In an aspect of the present invention, the switch may be exposed to the inner surface direction of the first case 110 through the switch receiver 307 in which the switch may be installed. In this case, when the user presses an input portion (for example, a button) of the switch exposed to the inner surface of the first case 110, the ON or OFF of the earphone may be changed. Additionally, the switch may also be replaced with volume adjusting buttons (− button and + button) that are generally formed at one position of the side of the mobile terminal. That is, when the user presses the − button or the + button of the volume adjusting buttons so that the volume has a specific value, a speaker mode or an earphone mode may be automatically switched to another mode.

Otherwise, when the volume has a specific threshold value, an idle mode operates so that none of the speaker and the earphone may output an audio signal. In this case, when the volume is higher or lower than a specific threshold point, the idle mode may be switched to the speaker mode or the earphone mode.

For example, in a case where the volume threshold value is 5, when the volume is changed from 4 to 5, the earphone mode may be switched into the idle mode. Here, when the + button is pressed, the volume becomes from 5 to 6 so that the idle mode may be switched to the speaker mode. In this situation (that is, when the volume is 6), the volume of the speaker mode may start with 1, and on the contrary, as the + button is pressed, the volume of the speaker mode is increased. On the contrary, when the volume becomes from 6 to 5, the speaker mode may be switched to the idle mode. Further, when the − button is pressed, the volume becomes from 5 to 4 so that the idle mode may be switched to the earphone mode. In this situation (that is, when the volume is 4), the volume of the earphone mode may start with 1, and as the − button is pressed, the volume of the earphone mode is increased.

Additionally, the aforementioned operations may be controlled by an application and the like that are installed in the mobile terminal.

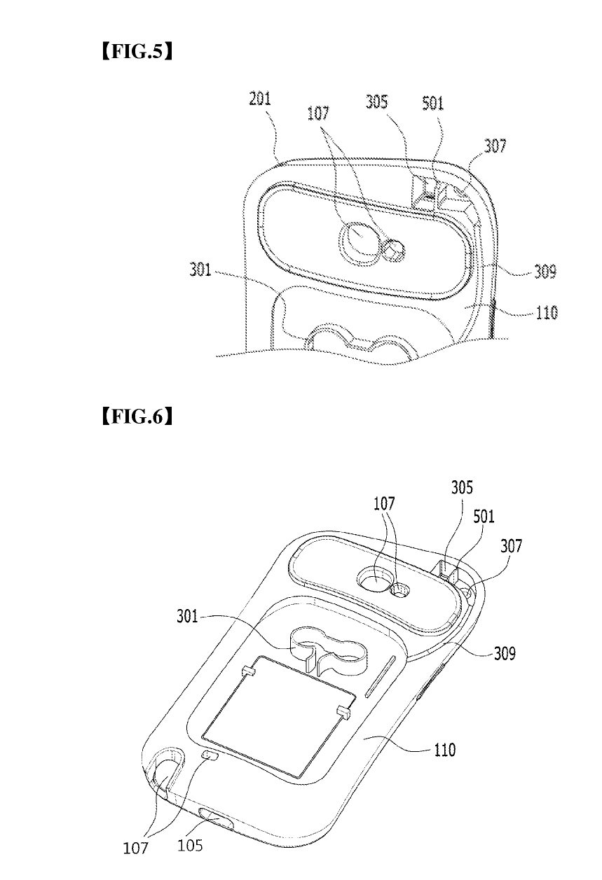

FIG. 5 is an enlarged view of the first case (that is, the inner layer) according to the exemplary embodiment of the present invention. As described above, the first case 110 of the earphone-integrated mobile terminal case 100 may include the antenna aperture 201, the terminal module aperture 107, the earphone receiver 301, the earphone jack receiver 305, the switch receiver 307, and the earphone line path 309.

In an aspect of the present invention, a partition wall is formed between the earphone jack receiver 305 and the switch receiver 307 of the first case 110. A groove 501 is formed at one side of the partition so as for the earphone line of the earphone to pass through the earphone line path 309. Accordingly, the earphone line of the earphone may be inserted into and fixed to the groove 501.

Additionally, the partition wall may include an aperture passing through the partition wall. In this case, since the earphone line of the earphone passes through the aperture, the earphone may be connected with other components while being fixed.

FIG. 6 is a perspective view illustrating the first case from which the winding roller is separated according to the exemplary embodiment of the present invention. According to an aspect of the present invention, the winding roller may be independently manufactured and installed in the first case 110.

As described above, the first case (that is, the inner layer) 110 of the earphone-integrated mobile terminal case may include the terminal module aperture 107 which exposes terminal modules, the earphone receiver 301 which is integrally installed on the first case so as to fix the earphone speaker of the earphone, the earphone jack receiver 305 which may receive the earphone jack (not illustrated) integrally coupled to the first case 110, the switch receiver 307 which forms a space capable of receiving the switch for controlling the ON/OFF of the earphone, and the earphone line path 309 which includes the groove for fixing the earphone line of the earphone. In an aspect of the present invention, the aforementioned components may be manufactured or formed integrally with the first case 110, unlike the winding roller. In an additional aspect of the present invention, the winding roller may also be manufactured or formed integrally with the first case 110.

As illustrated in FIG. 6, in an aspect of the present invention, since the earphone receiver 301 is formed at the upper portion of the first case 110, it is possible to make users more conveniently grip the mobile terminal as compared to when using a mobile terminal in which the earphone receiver is formed at a lower portion of the first case 110. This is because the users of a mobile terminal generally use the mobile terminal while gripping the lower portion of the back surface of the mobile terminal

It is also possible to adjust the position of the convex portion of the mobile terminal case by appropriately adjusting the aforementioned position of the earphone receiver. Accordingly, it is also possible to provide users with differentiated grip for convenience.

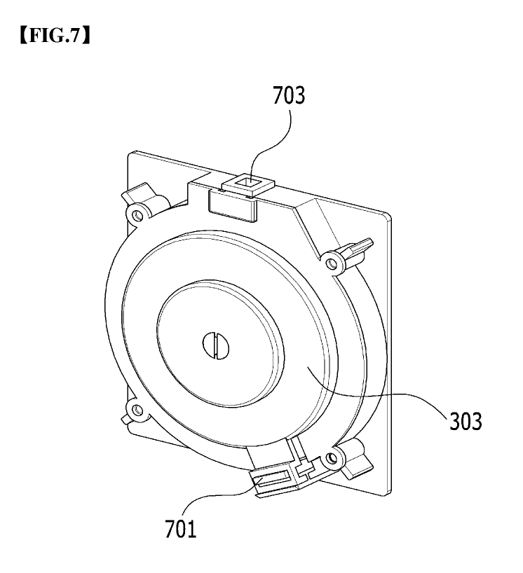

FIG. 7 is a perspective view illustrating the winding roller, which is separated from the first case, according to the exemplary embodiment of the present invention. In an aspect of the present invention, the winding roller 303 may be manufactured separately from the first case and installed at a lower portion of the earphone receiver in the first case. Additionally, since the winding roller may be installed at an upper portion of the earphone receiver and a lower portion of the earphone jack receiver, the earphone line of the earphone may be more effectively disposed. In this case, it is possible to achieve efficiency for a length of the earphone line.

As illustrated in FIG. 7, the winding roller 303 may include an aperture 701 through which the earphone line of the earphone may be led, and an aperture 703 through which the earphone line may be drawn. The rotating portion (not illustrated), which may rotate about the cylindrical projection, is provided within the winding roller 303 such that the earphone line of the earphone may be inserted into the groove, which is formed around the rotating portion, so as to be wound or unwound.

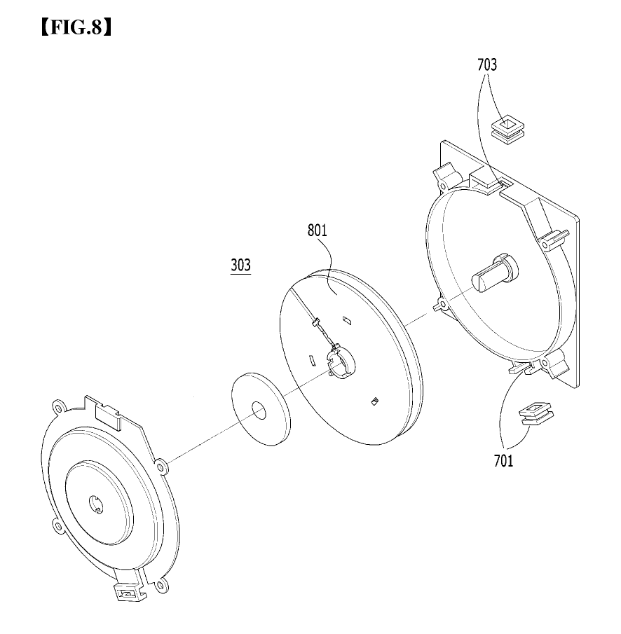

FIG. 8 is an exploded view illustrating the components of the winding roller according to the exemplary embodiment of the present invention. As illustrated in FIG. 8, the winding roller 303 may include the cylindrical projection which is formed at the central part of the winding roller, a cylindrical rotating portion 801 which includes a cylindrical passage, through which the cylindrical projection may be inserted, at the central part, a cover which covers the cylindrical rotating portion, and inlet and outlet frames 701 and 703 of the earphone line of the earphone.

The cylindrical projection may be inserted into the cylindrical passage from a lower side to an upper side of the cylindrical passage such that the cylindrical rotating portion 801 may rotate about the cylindrical projection. The groove with a predetermined depth is made at a side circumference of the cylindrical rotating portion 801 so that the earphone line of the earphone may be inserted into the groove so as to be wound or unwound. Additionally, the ring-shaped fastening portion may be coupled to the side circumference of the cylindrical rotating portion 801 so as to fix the earphone line.

In an aspect of the present invention, an elasticity member, such as a spring, is wound at the groove and the circumference of the cylindrical projection such that the earphone line of the earphone, which is pulled, may be rewound by elastic restoring force of the elasticity member.

In an aspect of the present invention, the cover for covering the cylindrical rotating portion may be coupled to the inlet and outlet frames 701 and 703 so as to form at least two apertures for forming a passage through which the earphone line may be led into or drawn from the winding roller 303.

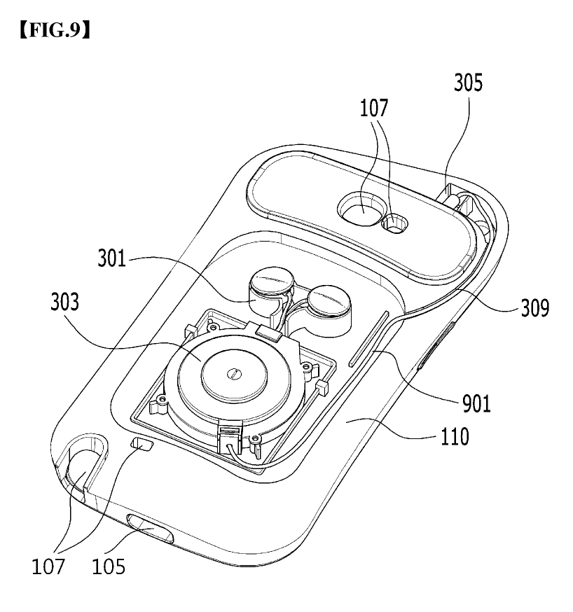

FIG. 9 is a perspective view illustrating an outer surface of the first case (the inner layer) of the earphone-integrated mobile terminal case according to the exemplary embodiment of the present invention. As illustrated in FIG. 9, earphone 901 may be fixed and coupled to the earphone jack receiver 305, connected from the earphone jack receiver 305 along the earphone line path 309, led into the winding roller 303, wound in the winding roller 303, drawn from the winding roller 303, and inserted into and fixed to the earphone receiver 301.

The description about the suggested exemplary embodiments is provided so that a person with ordinary skill in the art to which the present invention pertains may use or carry out the present invention. Various modifications from the exemplary embodiments will be obvious to the person skilled in the art, and general principles defined herein may be applied to other exemplary embodiments without departing from the scope of the present invention. Accordingly, the present invention is not limited to the exemplary embodiments suggested herein, but should be construed within the widest scope that complies with the principles suggested herein and novel features.

1. An earphone-integrated mobile terminal case, comprising:
a first case configured to form a housing, wherein the housing is configured to accommodate therein a mobile terminal;
a second case configured to be coupled to the housing of the first case, wherein the second case comprises an aperture configured to expose an earphone speaker of an earphone to an outside of the housing;
an earphone jack of the earphone, positioned in the first case, wherein the earphone jack is configured to be directly coupled to an audio output port of the mobile terminal when the mobile terminal is accommodated in the housing of the first case; and
a winding roller configured to be included in an inside space formed by the first case and the second case, wherein the winding roller is further configured to wind an earphone line of the earphone; and
wherein the earphone is configured to be enabled or disabled based on a control of a software.

2. The earphone-integrated mobile terminal case as claimed in claim 1, wherein the earphone is further configured to be enabled or disabled based on control of a hardware switch.

3. The earphone-integrated mobile terminal case as claimed in claim 1, wherein an inside of the first case in which the mobile terminal is accommodated comprises an elasticity material.

4. The earphone-integrated mobile terminal case as claimed in claim 1, wherein the aperture comprises two circle holes.

5. The earphone-integrated mobile terminal case as claimed in claim 1, wherein an earphone line path is formed on the first case,
wherein the earphone line path comprises a groove forming a passage, and
wherein the earphone line of the earphone is inserted into the passage and led to the winding roller.

6. The earphone-integrated mobile terminal case as claimed in claim 1, further comprising:
an earphone receiver
formed on a portion of the first case corresponding to the aperture of the second case, and
configured to receive an earphone speaker of the earphone by encompassing the received earphone speaker.
